(19) United States
(12) Patent Application Publication
(10) Pub. No.: US 2012/0247432 A1
(43) Pub. Date: Oct. 4, 2012

(54) EVAPORATIVE EMISSION PURGING SYSTEM

(75) Inventor: Robert Cardno, Novi, MI (US)

(73) Assignees: DENSO CORPORATION, Kariya-Shi (JP); DENSO INTERNATIONAL AMERICA, INC., Southfield, MI (US)

(21) Appl. No.: 13/085,634

(22) Filed: Apr. 13, 2011

Related U.S. Application Data
(60) Provisional application No. 61/469,484, filed on Mar. 30, 2011.

(51) Int. Cl. F02M 33/04

(52) U.S. Cl. 123/518

(57) ABSTRACT

In order to create enough vacuum pressure for the evaporative emissions, to be drawn into the intake air of an internal combustion engine, the present disclosure recites a purge booster disposed in the airflow between the intake air compressor and the air cleaner, the purge booster has a venturi tube comprising a gradually narrowed inner surface with an introduction passage therein. The airflow drawn from the air cleaner to the intake air compressor passes the inside space of the narrowed inner surface, thus, creating vacuum pressure for purging evaporative emissions by venturi.

### CROSS-REFERENCE TO RELATED APPLICATIONS

This application claims the benefit of U.S. Provisional Application No. 61/469,484, filed on Mar. 30, 2011. The disclosure of the above application is incorporated herein by reference in its entirety.

### FIELD

The present disclosure relates to an evaporative emission purging system for a vehicle.

### BACKGROUND

Generally, the evaporative emissions are stored in the vapor canister, and then sucked into intake manifold of an internal combustion engine via a purge valve. Recently, internal combustion engines are designed to be more compact, and efficient due to the requirements of fuel economy and/or saving the environment. Such compact high efficiency engines have small displacement, run for longer periods with open throttle, and eventually may not create much vacuum pressure. Thus, it is difficult to recover the evaporative emissions by drawing them into the intake manifold for such a compact engine.

Japanese unexamined Patent Application Publication No. 5-10216 discloses an evaporative emission purging system for a vehicle having an engine equipped with turbo charger. The evaporative emission purging system purges evaporative emissions into intake air, upstream of the turbo charger. However, since this evaporative emission purging system uses vacuum pressure of the turbo charger as it is, it may be difficult to create enough vacuum pressure for purging the evaporative emissions.

### SUMMARY

In order to create enough vacuum pressure for the evaporative emissions, the present disclosure describes a vapor canister connected to the fuel tank, wherein the vapor canister stores evaporative emissions generated in the fuel tank, a purge valve connected to the outlet of the vapor canister, a purge booster connected to the outlet of the purge valve, the purge booster being disposed between the intake air compressor and the air cleaner in the airflow. The purge booster comprises a venturi tube having a gradually narrowed inner surface, and the venturi tube defines an introduction passage on the narrowed inner surface. The introduction passage purges the evaporative emissions to an inside space of the narrowed inner surface, wherein, the airflow from the air cleaner to the intake air compressor passes through the inside space of the narrowed inner surface. The gradually narrowed inner surface of the purging booster is able to create lower pressure relative to the prior art. Thus, enough vacuum pressure for purging evaporative emissions may be created by the venturi effect by the gradually narrowed inner surface.

Another aspect of this disclosure is, the purge booster further comprises a main induction pipe. The main induction pipe has a cylindrical shape, and is connected to an air passage from the air cleaner to the intake air compressor wherein, the venturi tube is located in the main induction pipe. With the main induction pipe, the venturi tube can be located near the center of the airflow blown into the main induction pipe, where the airflow speed is relatively higher than the peripheral portion. Further, the airflow passing into the intake air compressor can pass around the venturi as well as through the venturi which reduces the pressure loss impact of the device.

Still, another aspect of this disclosure is, the venturi tube comprises an axial length wherein, the edge portions of the venturi tube are axially shifted from the edge portions of the main induction pipe. Therefore, the venturi tube may create the low pressure with less influence from the edge portions of the main induction pipe.

Yet, another aspect of this disclosure is, the venturi tube is supported by spokes protruding from an inside surface of the main induction pipe. Moreover, the spokes are flat fins extending along the airflow from the air cleaner to the intake air compressor. Also, the purge booster is disposed adjacent to the inlet of the intake air compressor relative to an outlet of the air cleaner.

Further areas of applicability will become apparent from the description provided herein. It should be understood that the description and specific examples are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of an evaporative emissions pursing system for a vehicle in the present disclosure;

FIG. 2 is a perspective view of purge booster in the present disclosure;

FIG. 3 is a sectional view of purge booster in the present disclosure; and

FIG. 4 is another sectional view of purge booster in the present disclosure.

Corresponding reference numerals indicate corresponding elements throughout the several views of the drawings.

### DETAILED DESCRIPTION

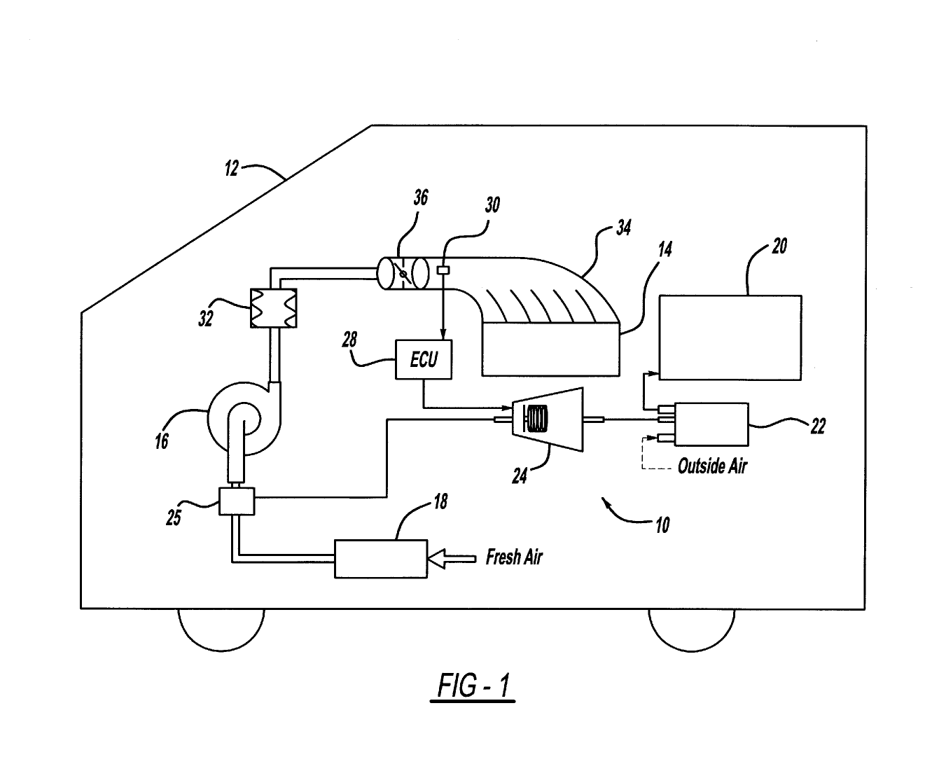

The preferred embodiments will now be described more fully with reference to FIGS. 1-4 of the accompanying drawings.

FIG. 1 is a schematic view of an evaporative emissions purging system 10 for a vehicle 12 of this preferred embodiment. The vehicle 12 comprises an internal combustion engine 14, intake air compressor 16 for the internal combustion engine 14, air cleaner 18 disposed in an upstream side in the airflow of the intake air compressor 16, and a fuel tank 20 for the internal combustion engine 14. In this embodiment, the intake air compressor 16 is a turbocharger 16 powered by exhaust gas flow. The intake air compressor 16 may be a super charger powered by the internal combustion engine.

As illustrated, vapor canister 22 is connected to the fuel tank 20, purge valve 24 is connected to the outlet of the vapor canister 22, and purge booster 25 is connected to the outlet of purge valve 24. Purge booster 25 is disposed between turbocharger 16 and air cleaner 18 in the airflow. Evaporative emissions are generated in the fuel tank 20, and once generated, stored in vapor canister 22. Vapor canister 22 may also take in outside air in accordance with its internal pressure. Vapor canister 22 is connected to controlled purge valve 24, wherein the controlled purge valve 24 is controlled by ECU 28. ECU 28 receives airflow amount information from airflow sensor 30, and opens the controlled purge valve 24 based on the desired airflow amount. The evaporative emissions relieved from controlled purge valve 24, is drawn by the turbo charger via purge booster 25. The turbo charger is operated by exhaust gas flow, and sucks fresh air via air cleaner 18. The air cleaner 18 accommodates air filter (not shown). The turbo charger compresses the drawn fresh air and discharges the same to internal cooler 32. The internal cooler 32 exchanges heat between outside air/water and compressed air to be cooled. The internal combustion engine 14 sucks the cooled compressed air through intake manifold 34. The intake manifold 34 accommodates throttle valve 36 and the pressure sensor 30, wherein the throttle valve 36 controls the intake air amount based on the driver's operation.

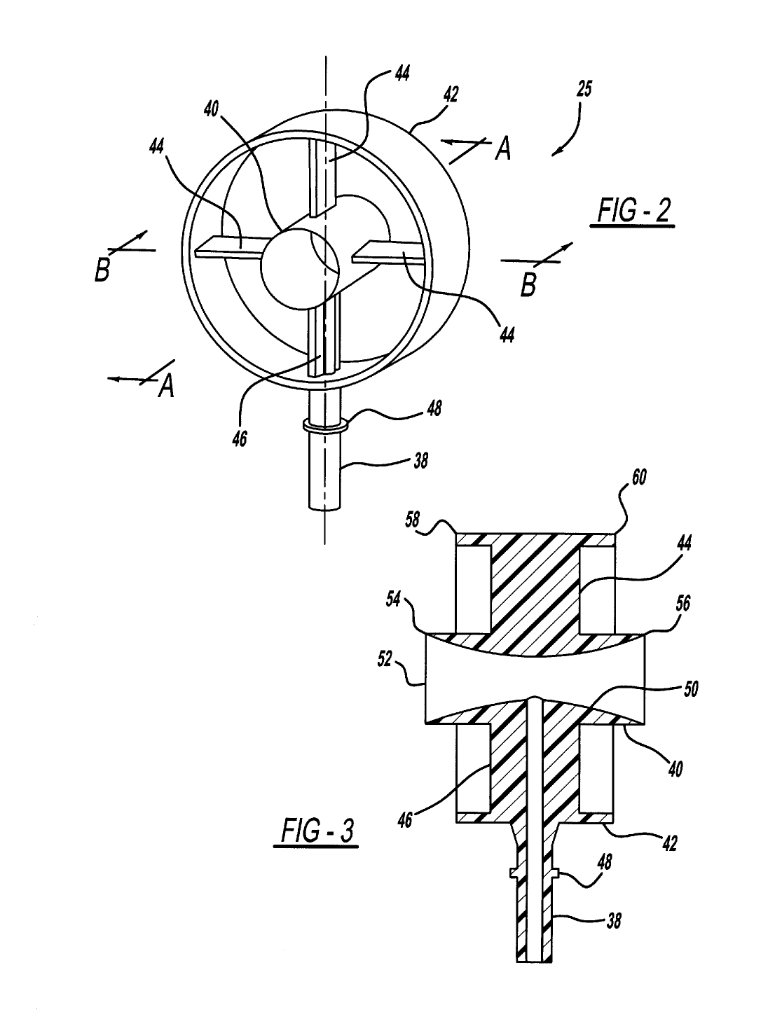

FIG. 2 shows a perspective view of the purge booster in this embodiment. The purge booster has purge tube 38, venturi tube 40, and main induction pipe 42. The main induction pipe 42 has a cylindrical shape, and is connected to an air passage between the intake air compressor 16 and the air cleaner 18. The venturi tube 40 is coaxially located in the main induction pipe 42. With the main induction pipe 42, and may be located in or near the center of the airflow blown into the main induction pipe 42, where the airflow speed is relatively higher than the peripheral portion.

In this embodiment, the venturi tube 40 is supported by 3 spokes 44 protruding from an inside surface of the main induction pipe 42. The spokes 44 have a flat fin shape extending along the airflow from the air cleaner 18 to the intake air compressor 16. The purge tube 38 has a fin 46 extending along the airflow from the air cleaner 18 to the intake air compressor 16.

The purge booster 25 is disposed adjacent to the inlet of the intake air compressor 16 relative to an outlet of the air cleaner 18. The purge tube 38 is connected to an outlet of the controlled purge valve 24. The purge tube 38 has flange 48 positioned a predetermined distance below the main induction pipe 42 for purposes of hose retention.

FIG. 3 is a cross sectional view of purge booster 25 viewed along arrow A of FIG. 2. The inside surface of the venturi tube 40 is gradually narrowed from its edge portions to its middle portion. In other words, venturi tube 40 has a gradually narrowed inner surface 50. The venturi tube 40 defines an introduction passage 52 on the narrowed inner surface, wherein the introduction passage 52 is an outlet of purge tube 38. The introduction passage 52 purges the evaporative emissions received from the purge tube to the inside space of the narrowed inner surface. The airflow from air cleaner 18 to the turbocharger 16 passes the inside space of the narrowed inner surface, wherein the gradually narrowed inner surface 50 may create low pressure for purging evaporative emissions. The edge portions 54, 56 of the venturi tube 40 are axially shifted from the edge portions 58, 60 of the main induction pipe 42. In this embodiment, the length of the venturi tube 40 is different form the main induction pipe 42, more specifically, the length of the venturi tube 40 is longer than that of the main induction pipe 42. Thus, both edge portions 54, 56 of the venturi tube 40 are axially elongated, relative to the edge portions 58, 60 of the main induction pipe 42. Therefore, the venturi tube 40 may create the low pressure with less influence from the edge portions 58, 60 of the main induction pipe 42.

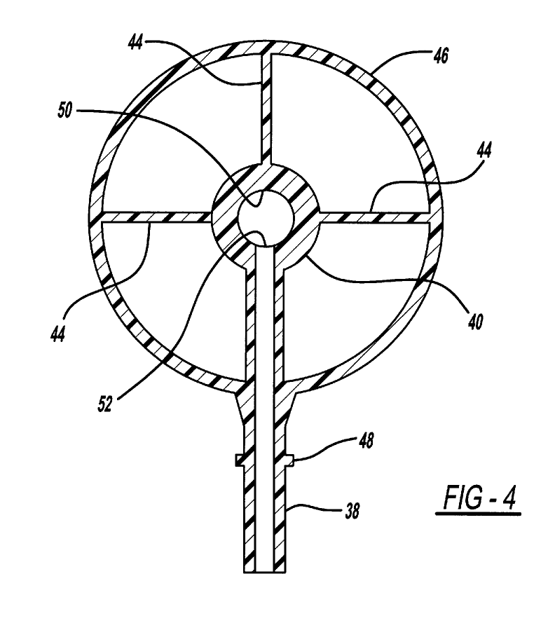

FIG. 4 is another sectional view of purge booster 25 viewed along arrow B of FIG. 2. In this embodiment, the purge booster 25 comprises an integral resin member.

With the evaporative emission purging system 10 explained above, the evaporative emissions are drawn in by the incoming airflow to the turbo charger. The purge booster 25 may create a venturi effect, and discharge the evaporative emissions into the intake air. Therefore, even if the size of the internal combustion engine 14 is small, the evaporative emissions are effectively drawn by the turbocharger 16 via purge booster 25 via the incoming airflow independent of the vacuum levels seen in the intake manifold 34.

The system explained above, purges the evaporative emissions into the intake air before being compressed, so there is not need for a check valve in the purge tube 38, and furthermore, the affect to the stoichiometric ratio may be relatively smaller than the prior art, which charges evaporative emissions into the charged intake air.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the Figures. Spatially relative terms may be intended to encompass different orientations of the device in use or operation in addition to the orientation depicted in the Figures. For example, if the device in the Figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claim is:

1. An evaporative emission purging system for a vehicle, the vehicle comprising an internal combustion engine, intake air compressor for the internal combustion engine, an air cleaner disposed in an upstream side in airflow of the intake air compressor, and a fuel tank for the internal combustion engine, the evaporative emission purging system comprising:
a vapor canister connected to the fuel tank, the vapor canister storing evaporative emissions generated in the fuel tank;
a purge valve connected to the outlet of the vapor canister, and
a purge booster connected to the outlet of the purge valve, the purge booster being disposed in the airflow between the intake air compressor and the air cleaner,
wherein,
the purge booster comprises a venturi tube having a gradually narrowed inner surface,
the venturi tube defines an introduction on the narrowed inner surface, the introduction passage receiving the evaporative emissions to an inside space of the narrowed inner surface, and
wherein,
the airflow from the air cleaner to the intake air compressor passes the inside space of the narrowed inner surface.

2. The evaporative emission purging system for a vehicle according to claim 1, wherein, the purge booster further comprises a main induction pipe, said main induction pipe having a cylindrical shape, and being connected to an air passage to the intake air compressor and an air passage form the air cleaner, wherein the venturi tube is located in the main induction pipe.

3. The evaporative emission purging system for a vehicle according to claim 2, wherein, edge portions of the venturi tube are axially shifted from edge portions of the main induction pipe.

4. The evaporative emission purging system for a vehicle according to claim 2, wherein, the venture tube is supported by a plurality of spokes protruding from an inside surface of the main induction pipe.

5. The evaporative emission purging system for a vehicle according to claim 4, wherein, the plurality of spokes comprise flat fins extending along the airflow from the air cleaner to the intake air compressor.

6. The evaporative emission purging system for a vehicle according to claim 1, wherein, the purge booster is disposed adjacent to an inlet of the intake air compressor relative to an outlet of the air cleaner.

7. An evaporative emission purging system for a vehicle comprising:
a internal combustion engine;
an intake air compressor for the internal combustion engine;
an air cleaner disposed in an upstream side of the intake air compressor;
a fuel tank for storing fuel of the internal combustion engine;
a vapor canister connected to the fuel tank, said vapor canister storing evaporative emissions generated in the fuel tank;
a purge valve connected to an outlet of the vapor canister, and
a purge booster connected to an outlet of the purge valve, the purge booster being disposed in line between the intake air compressor and the air cleaner,
wherein,
the purge booster comprises a venturi tube having a gradually narrowed inner surface, defining an introduction passage on the narrowed inner surface, the introduction passage receiving the evaporative emissions to an inside space of the narrowed inner surface, and
the airflow from the air cleaner to the intake air compressor passes the inside space of the narrowed inner surface.
